(19) United States
(12) Patent Application Publication
(10) Pub. No.: US 2018/0308656 A1
(43) Pub. Date: Oct. 25, 2018

(54) X-RAY TUBE

(71) Applicant: SHIMADZU CORPORATION, KYOTO (JP)

(72) Inventor: ATSUSHI YAJIMA, KYOTO (JP)

(73) Assignee: SHIMADZU COPROATION, KYOTO (JP)

(21) Appl. No.: 15/952,362

(22) Filed: Apr. 13, 2018

(30) Foreign Application Priority Data
Apr. 20, 2017 (JP) 2017-083811

(51) Int. Cl. H01J 35/14; H01J 35/06

(52) U.S. Cl. CPC H01J 35/14; H01J 35/06

(57) ABSTRACT

An X-ray tube provides a reduced X-ray focal point without enlargement of the device. Relative to a rotating envelope X-ray tube an angle θ between an emission direction of an electron beam E and a target surface 4 of an anode 3 is at most 90 degrees and preferably, the incident angle α is at most 25 degrees and more preferably at most 12 degrees, and in addition, an emitter 2 has a tabular (flat) electron emission element.

### CROSS REFERENCE TO RELATED APPLICATIONS

This application relates to, and claims priority from JP 2017-083811 filed Apr. 20, 2017, the entire contents of which are incorporated herein fully by reference.

### FIGURE SELECTED FOR PUBLICATION

FIGS. 8A, 8B

### BACKGROUND OF THE INVENTION

### Field of the Invention

The present invention relates to a rotating envelope X-ray tube in which an anode, a cathode and an envelope housing the anode inside thereof rotates in a unified manner.

### Description of the Related Art

The Patent Document 1 discloses the rotating envelope X-ray tube that comprises a cathode that emits an electron beam, an anode that emits an X-ray when the electron beam emitted from the cathode collides therewith, a magnetic field generator that collides an electron beam with the anode by deflecting the electron beam emitted from the cathode, and an envelope that houses the cathode and the anode inside thereof, and the anode and the envelope rotate in a unified manner.

With regard to the conventional rotating anode X-ray tube in which the anode rotates, cooling thereof is subjected to radiation and the heat capacity is increased by enlarging the size of the anode so that a long-time emission (lighting) is feasible. On the other hand, with regard to the rotating envelope X-ray tube as set forth above, the anode is thermally connected to the outside thereof, so that the size of the entire X-ray tube can be made smaller by cutting the size of the anode.

In addition, according to the Patent Document 2, it is known that the size of the X-ray focal point is improved by using the cathode (emitter) having an electron emission element formed to be substantially flat. In addition, according to the Patent Document 3, it is known that a quadrupole lens having a pair of quadruples between the cathode and the anode is installed, so that the size of the X-ray focal point can be controlled.

### RELATED PRIOR ART DOCUMENTS

### Patent Document

Patent Document 1: JPG 10-69869 A
Patent Document 2: U.S. Pat. No. 6,646,366 B
Patent Document 3: U.S. Pat. No. 7,839,979 B

### ASPECTS AND SUMMARY OF THE INVENTION

### Objects to be Solved

The size of the electron beam emitted from the cathode is a minimum at the plane perpendicular to the traveling direction of the electron beam. Therefore, it is desirable that an angle between the traveling direction of the electron beam and the anode (target) surface is normal. On the other hand, in the conventional rotating envelope X-ray tube, the angle between the traveling direction of the electron beam and the anode surface is approximately 12 degrees slanted from the normal in connection with an eyesight of the X-ray. Given the slant is at such degree, the variation of the size of the X-ray focal point relative to the size of the incident electron beam is in the ignorable level.

On the other hand, in the X-ray tube of the rotating envelope X-ray tube as set forth above, the emission direction of the electron beam from the cathode and the rotation axis direction of the envelope are coaxial and such electron beam is deflected to collide with the anode, so that the electron beam is incident at a low-angle to the target surface of the anode. Specifically, the incident angle, i.e., the crossing angle between the trajectory of the electron beam when the electron beam collides with the target surface of the anode following emission from the cathode and the normal line on the target surface, is large. In such way, when the incident angle of the electron beam is large, it is problematic that the diameter of the X-ray focal point, which is emerged due to the collision with the target surface, broadens in the deflection direction. In addition, when the incident angle of the electron beam is large, the backscattered electron increases, so that it is problematic that the obtainable X-ray amount decreases even when the same electric tube current is provided. When the electric tube current is increased to correspond with such an X-ray amount decrease, the diameter of the electron beam becomes large due to the space-charge effect.

The inventor sets forth such aspects referring to FIG. 14 and FIG. 15. FIG. 14 and FIG. 15 are explanatory views illustrating an incident angle α of the electron beam E relative to the anode 3.

Referring to FIG. 14, relative to the conventional X-ray tube of the rotating anode model, the target surface 4 of the anode 3 is formed to be slanted with an angle A, and as indicated by the broken line in FIG. 14, when the electron beam E is irradiated toward the target surface 4 in the vertical direction relative to the anode 3, the incident angle α of the electron beam E relative to the target surface 4 is A.

The length L of the reflected electron (X-ray) relative to the incident electron is given by the following formula if the incident angle of the electron beam E relative to the target surface 4 is α.

L=1/cos α

Therefore, if A is 12 degrees, i.e., the incident angle is 12 degrees, the length L is 1.02 times long. Therefore, if the incident angle is 25 degrees, the elongation L is 1.1 times long. In any case, the elongation L is in the ignorable range.

The ratio η of the reflected electron (X-ray) relative to the incident electron is given by the following formula if the incident angle of the electron beam E relative to the target surface 4 is α.

η=(1+cos α)−1.046

If the incident angle is 0 degrees, i.e., when the electron beam E is incident vertically to the target surface 4, the ratio η is 0.4846. On the other hand, if the incident angle is 12 degrees, the ratio η is 0.4899, so that the electron beam E involved in the X-ray emission is approximately 99% compared to when the incident angle is 0 degrees. On the other hand, if the incident angle is 25 degrees, the ratio η is 0.5092, so that the electron beam involved in the X-ray emission is approximately 95% compared to when the incident angle is 0 degrees. In any case, the ratio variation of the reflected electron is in the ignorable range.

In contrast, relative to the X-ray tube of the rotating envelope model, the electron beam E is incident with a lower angle relative to the target surface 4 of the anode 3. As indicated by the broken line in FIG. 15, when the electron beam E is incident toward the target surface 4 in the slanted direction with the angle B relative to the anode 3, the incident angle of the electron beam E incident to the target surface 4 is α as indicated in FIG. 15. For example, referring to FIG. 15, the angle B is 30 degrees and if the angle A, e.g., in FIG. 14, is 12 degrees, the incident angle α is 72 degrees and the elongation is 3.24 times long. In addition, if the incident angle α is 72 degrees, the η is 0.7545, so that the electrons involved in the X-ray emission decreases to a half amount compared to when the incident angle α is 0 (zero) degrees.

The drawback in which the electron beam E is incident with a low angle relative to the target surface 4 of the anode 3 (the incident angle α is large) can be improved to some extent by e.g., making a smaller anode of the rotating envelope X-ray tube or increasing the distance between the cathode and the anode. However, in the case of the former measures, making the small anode is limited due to the limitation of the heat dispersion of the anode, and in the case of the latter measures, the traveling (flight) distance of the electron is longer and consequently, an effect of the space-charge effect is larger and in addition, the size of the entire device is bigger.

The purpose of the present invention is to solve the above objects and to provide an X-ray tube capable of providing a smaller X-ray focal point without enlargement of the device.

### Means for Solving the Problem

A rotating envelope X-ray tube, according to an aspect of the claimed invention, comprises; a cathode that emits an electron beam; an anode that emits an X-ray when the electron beam emitted from the cathode collides therewith, a magnetic field generator that deflects the electron beam emitted from the cathode onto the anode; and an envelope that houses the cathode and the anode thereinside; wherein the anode and the envelope rotate together in a unified manner, and an angle between an emission direction of the electron beam emitted from the cathode and a target surface of the anode is at most (not more than) 90 degrees.

According to the rotating envelope X-ray tube of an aspect of another claimed invention, a crossing angle between a trajectory of the electron beam at the anode and a normal line on the target surface is at most 25 degrees.

A rotating envelope X-ray tube, according to an aspect of another claimed invention, comprises; a cathode that emits an electron beam; an anode that emits an X-ray when the electron beam emitted from the cathode collides therewith, a magnetic field generator that deflects the electron beam emitted from the cathode onto the anode; and an envelope that houses the cathode and the anode thereinside; wherein the anode and the envelope rotate together in a unified manner, and a crossing angle between a trajectory of the electron beam at the anode and a normal line on the surface is at most 25 degrees.

According to the rotating envelope X-ray tube of an aspect of another claimed invention, a crossing angle between a trajectory of the electron beam at the anode and a normal line on the surface is at most 12 degrees.

According to the rotating envelope X-ray tube of an aspect of the claimed invention, the anode further comprises an emitter having a planar (flat) electron beam emission surface.

The rotating envelope X-ray tube, according to an aspect of another claimed invention, further comprises a quadrupole lens, which consists of a pair of quadrupoles, between the cathode and the magnetic field generator.

A rotating envelope X-ray tube, according to an aspect of another claimed invention, the magnetic field generator is formed as a unit with the quadrupole of the pair of the quadrupoles, which is in the anode-side.

### Effect of the Invention

According to an aspect of the claimed invention, the angle between the emission direction of the electron beam emitted from the cathode and the target surface of the anode is at most 90 degrees (not more than 90 degrees), so that the crossing angle between the trajectory of the electron beam and the normal line on the target surface relative to the rotating envelope X-ray tube can be smaller. Therefore, the size of the entire device can be compact, and the diameter of the X-ray focal point can be smaller, and in addition, the electron beam can be utilized efficiently for the X-ray emission.

According to the rotating envelope X-ray tube of an aspect of another claimed invention, the crossing angle between the trajectory of the electron beam and the normal line on the target surface relative to the rotating envelope X-ray tube can be specified smaller. Therefore, the size of the entire device can be made compact and the diameter of the X-ray focal point can be made smaller.

According to the rotating envelope X-ray tube of an aspect of another claimed invention, the size of the X-ray focal point can be further smaller by using the anode comprising an emitter having a tabular electron beam emission surface.

According to the rotating envelope X-ray tube of an aspect of another claimed invention, the size of the X-ray focal point can be further smaller due to an action of the quadrupole lens consisting of the pair of the quadrupoles.

According to the rotating envelope X-ray tube of an aspect of another claimed invention, the entire device can be designed to be further smaller and as result, the traveling distance of the electron is shorter, so that the size of X-ray focal point can be made further smaller.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a schematic diagram illustrating a rotating envelope X-ray tube according to the aspect of the Embodiment 1 of the present invention.

FIG. 2 is a schematic front view of the magnetic field generator 5.

FIG. 3 is a schematic front view of the magnetic field generator 5.

FIG. 4 is a schematic front view of the magnetic field generator 5.

FIG. 5 is a schematic front view of the magnetic field generator 5.

FIG. 6 is a perspective view illustrating the emitter 2.

FIG. 7 is a plan view illustrating the emitter 2.

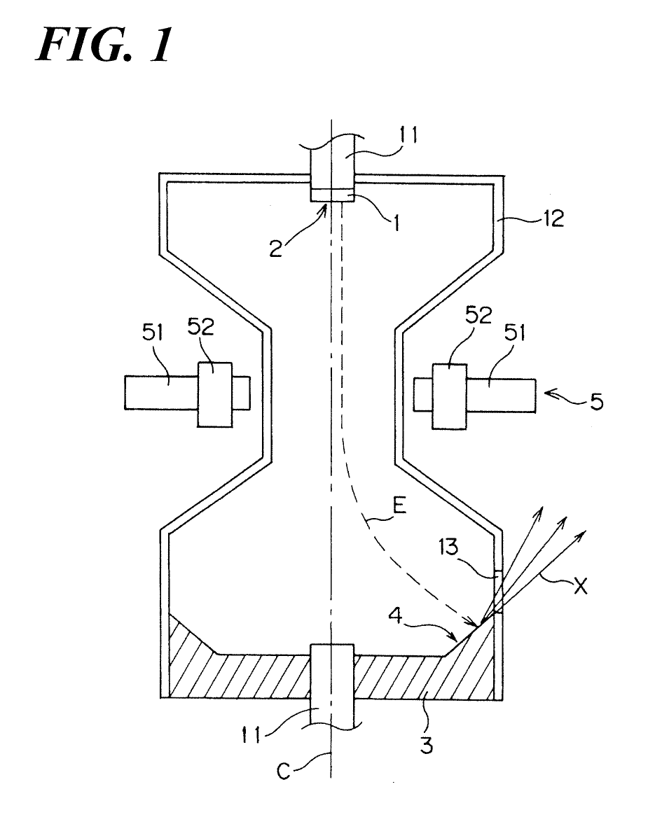

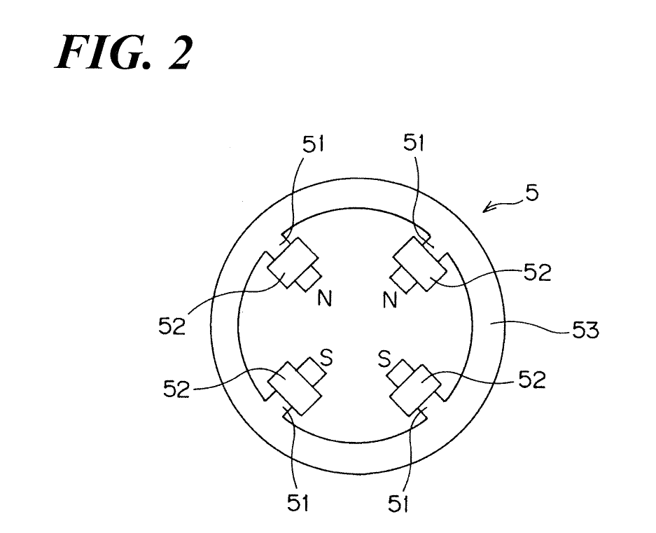

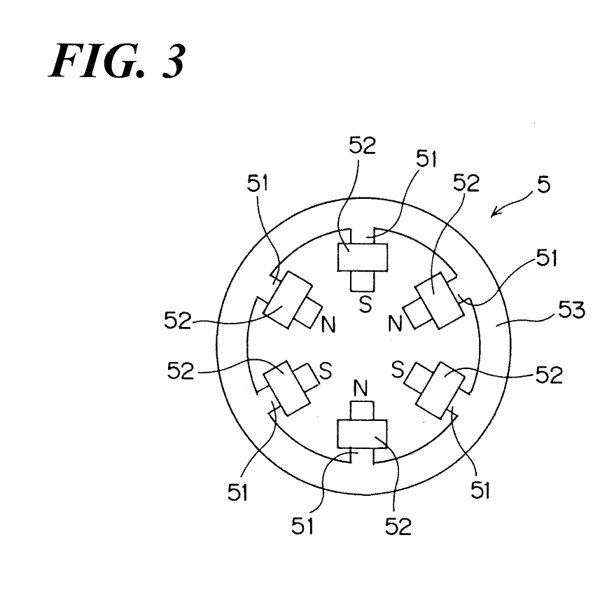

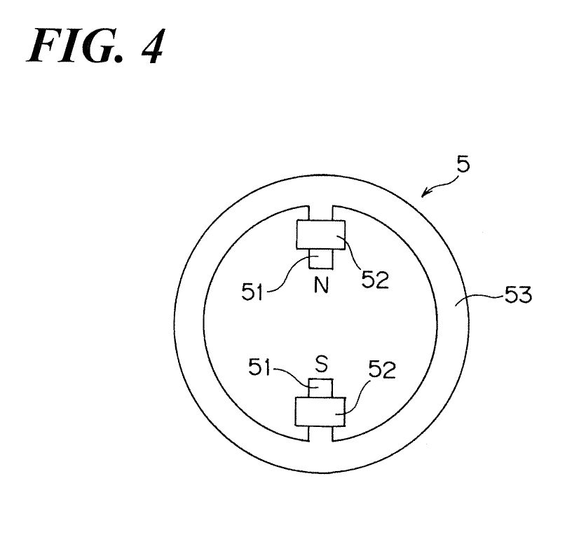

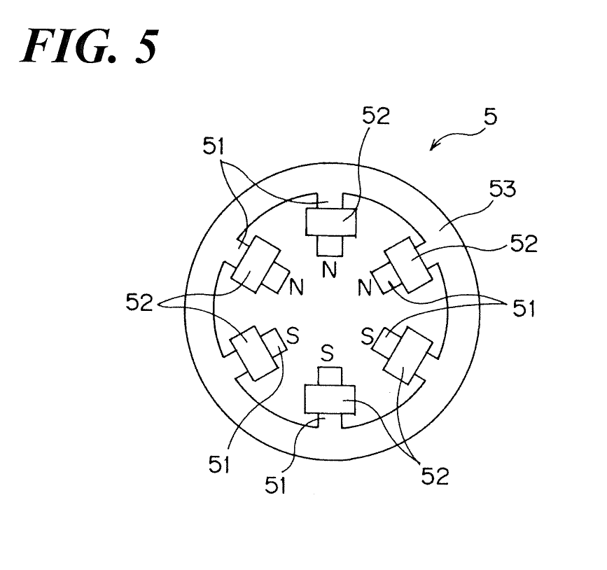

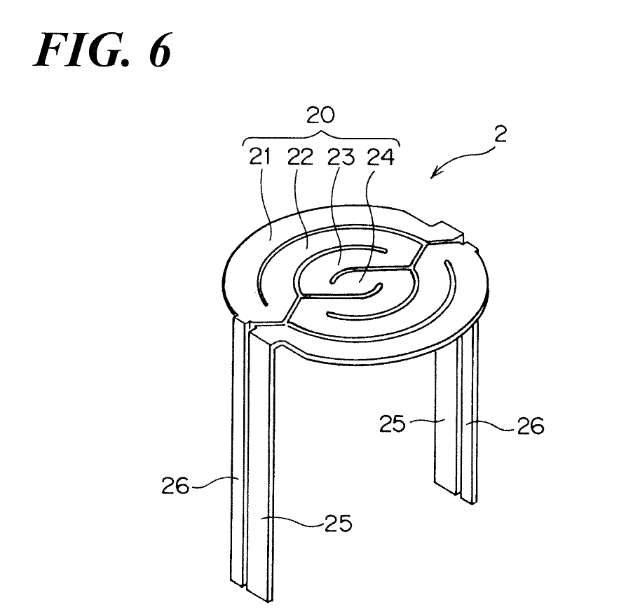

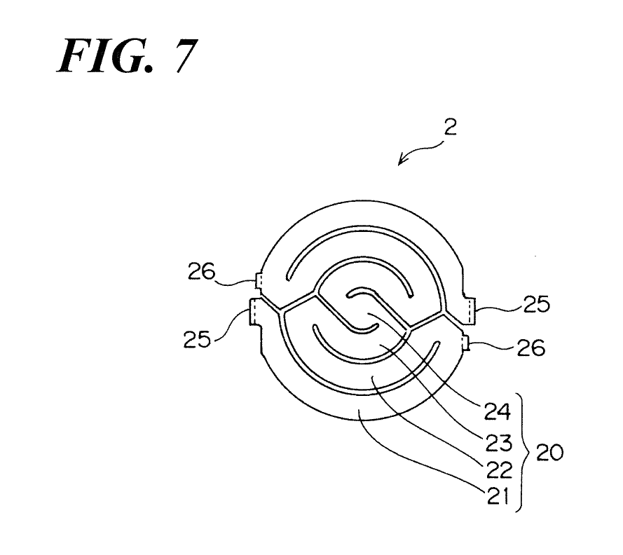

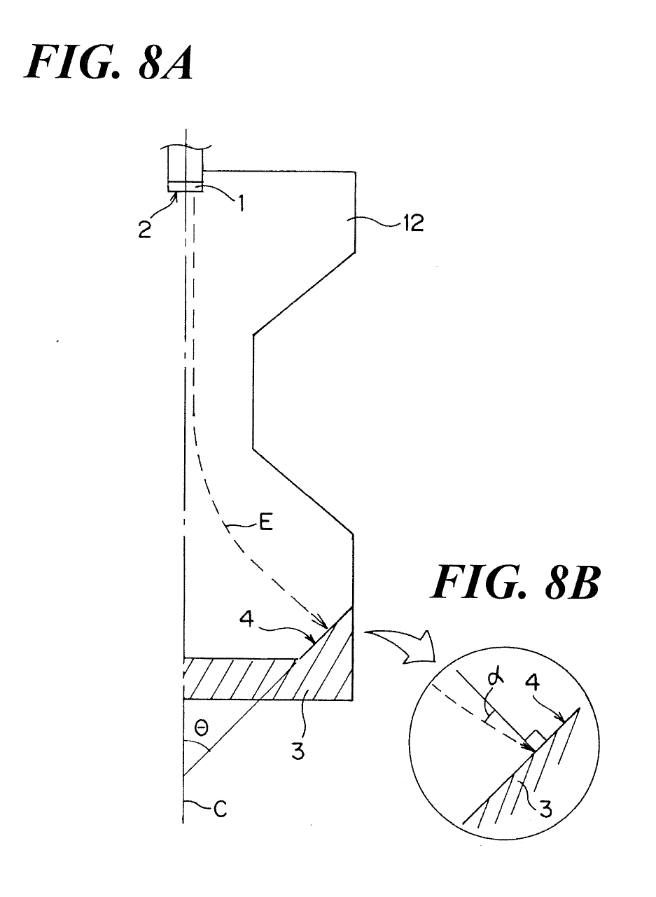

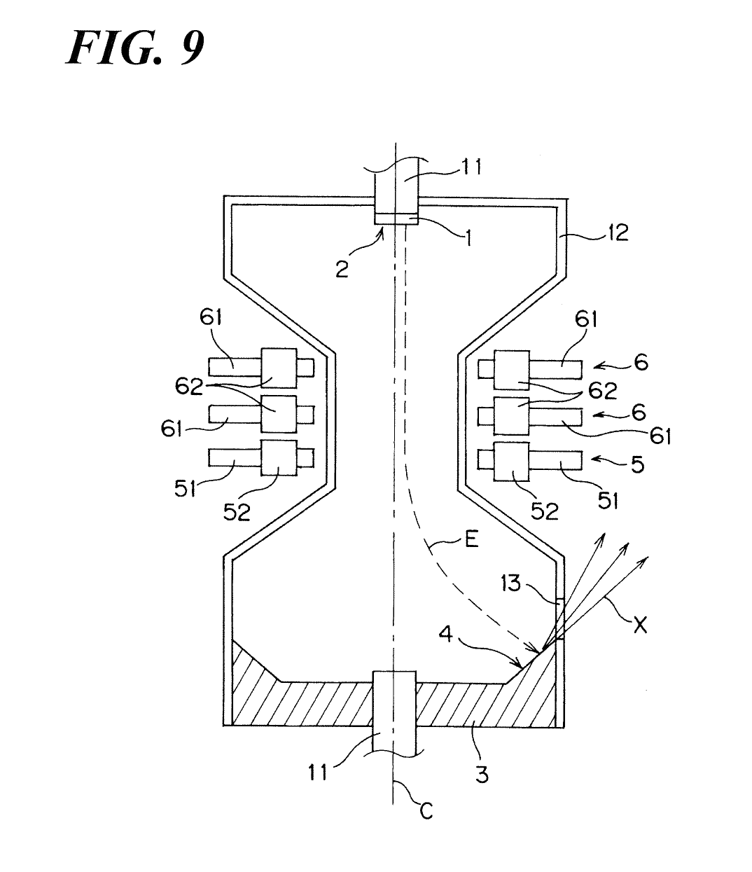

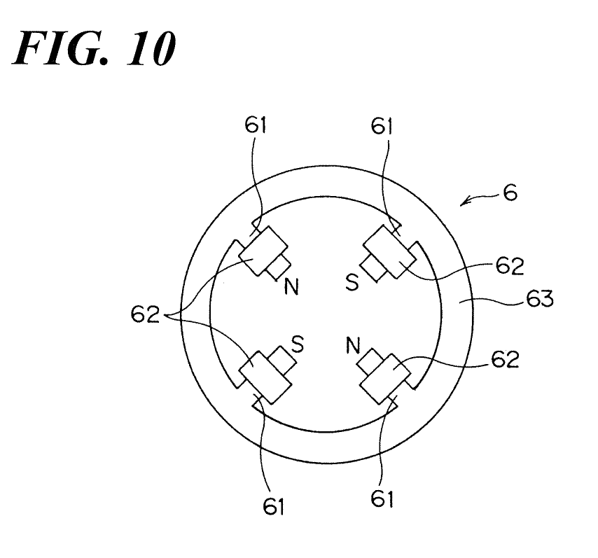

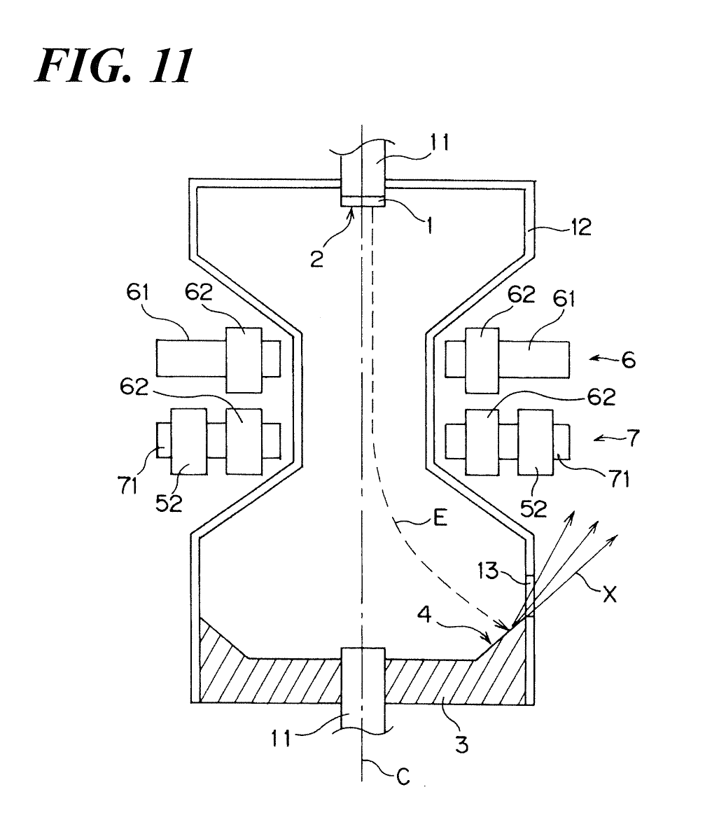

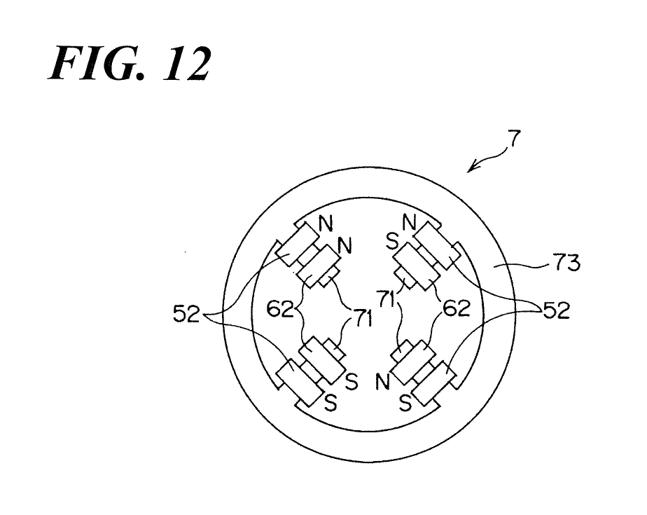

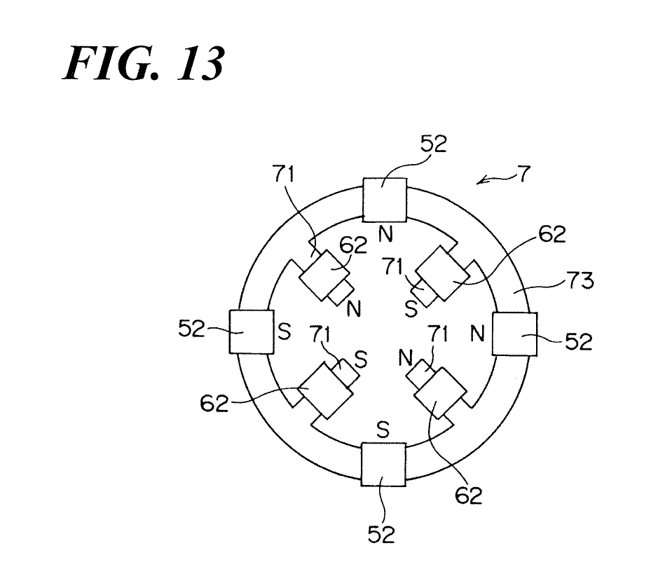

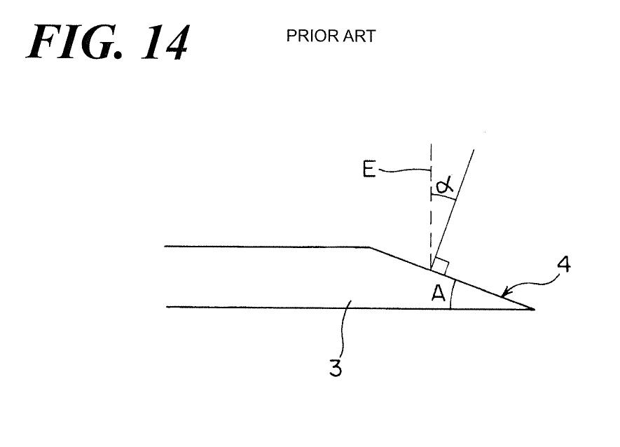

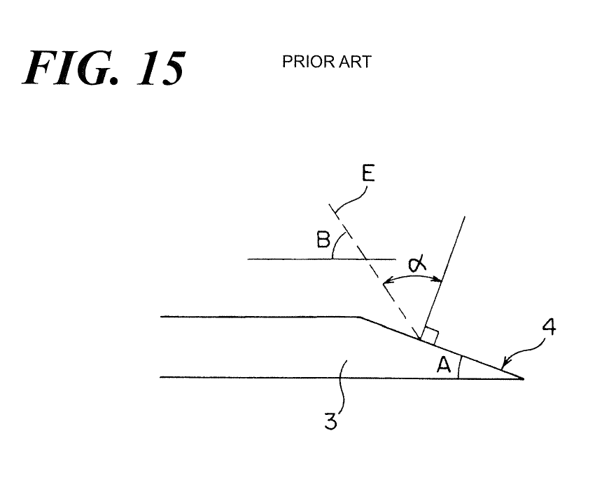

FIG. 8A is an explanatory view illustrating the angle of the target surface 4 and the incident angle α of the electron beam E relative to the rotating envelope X-ray tube according to the aspect of the present invention. FIG. 8B is a magnified view illustrating a portion of FIG. 8A.

FIG. 9 is a schematic diagram illustrating a rotating envelope X-ray tube according to the aspect of the Embodiment 2 of the present invention.

FIG. 10 is a schematic front view of the quadrupole 6.

FIG. 11 is a schematic diagram illustrating a rotating envelope X-ray tube according to the aspect of the Embodiment 3 of the present invention.

FIG. 12 is a schematic front view of the composite member 7.

FIG. 13 is a schematic front view of the composite member 7 according to the other Embodiment.

FIG. 14 is an explanatory view illustrating an incident angle α of the electron beam E relative to the anode 3.

FIG. 15 is an explanatory view illustrating an incident angle α of the electron beam E relative to the anode 3.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.
The inventor sets forth Embodiments of the present invention based on the following FIGs. FIG. 1 is a schematic diagram illustrating the rotating envelope X-ray tube according to the aspect of the Embodiment 1 of the present invention,

Such rotating envelope X-ray tube comprises an envelope 12 of which inside is a vacuum The envelope 12 rotates around the center of axis of a pair of rotation axes 11 as the rotation center by a motor, not shown in FIG. In addition, the cathode 1 comprising the emitter 2 having the tabular electron beam emission surface is installed at the tip location of the one of the rotation axes 11 inside the envelope 12. In addition, the anode 3 having the target surface 4 that emits an X-ray when the electron beam E from the cathode 1 collides therewith is installed at the end surface, facing the cathode 1, of the envelope 12. A high-voltage is added to the cathode 1 and the anode through the pair of the rotation axes 11 by a slip ring mechanism, not shown in FIG.

The electron beam emitted from the emitter 2 of the cathode 1 accelerates toward the anode 3 due to the action of the electric field generated by the high-voltage. And the electron beam E is deflected due to the action of the magnetic field generator 5 installed in the periphery of the envelope 12 and then collides with the target surface 4 of the anode 3 to result in an emission of the X-ray X. Such X-ray X is radiated to the outside from the opening 13 structured with an X-ray transmittable member formed on the envelope 12.

FIG. 2-FIG. 5 are schematic front views of the magnetic field generator 5 set forth above.

Referring to FIG. 2, the magnetic field generator 5 comprises; four protrusions 51 that are formed at even intervals relative to the circular yoke 53, and each coil 52 winding each protrusion 51. Relative to the magnetic field generator 5, the four protrusions 51 and the four coils 52 generate a pair of north poles (N-poles) at the upper side in FIG. 2 and a pair of south poles (S-poles) at the lower side therein.

Referring to FIG. 3, the magnetic field generator 5 comprises; six protrusions 51 that are formed at even intervals relative to the circular yoke 53, and each coil 52 winding each protrusion 51. Relative to the magnetic field generator 5, the six protrusions and the six coils 52 generate alternately the N-pole and the S-pole.

Referring to FIG. 4, the magnetic field generator 5 comprises; two protrusions 51 that are formed at even intervals relative to the circular yoke 53, and each coil 52 winding each protrusion 51. Relative to the magnetic field generator 5, the N-pole at the top in FIG. 4 and the S-pole at the bottom are generated.

Referring to FIG. 5, the magnetic field generator 5 comprises; six protrusions 51 that are formed at even intervals relative to the circular yoke 53, and each coil 52 winding each protrusion 51. Relative to such magnetic field generator 5, the six protrusions 51 and the coils 52 thereon generate three N-poles at the upper side in FIG. 5 and three S-poles at the lower side in FIG. 5. In addition, with respect to the magnetic field generator, the yoke protrusions are generally symmetrical relative to the deflection plane and it is acceptable that the poles formed by the corresponding coils are opposite to each other. In addition, the yoke has a circular shape for convenience sake, but the yoke 53 just needs to connect protrusions, so that the shape thereof can be e.g., a square. The deflection surfaces are not required to be symmetrical.

FIG. 6 is a perspective view illustrating the emitter 2. FIG. 7 is a plan view illustrating the emitter 2.

The emitter 2 that is made of pure tungsten or a tungsten alloy comprises a flat-plate (tabular) shape electron emission element 20, one pair of terminals 25, and one pair of support members 26. Such electron emission element 20, one pair of the terminals 25, one pair of the support members 26 are cutout from a single flat-plate material and are formed by a bending work in a unified manner.

Referring to FIG. 6, FIG. 7, the electron emission element 20 is formed into a tabular shape with the electric current pathway having a winding form (meander form), and the electron emission element 20 is formed circularly in a plane view. The central element 24 of the electron emission element 20 coincides with the rotation center C of the rotation axis 11 of the envelope 12, and the emitter 2 rotates around the central element 24 as the center along with rotation of the envelope 12.

The electron emission element 20 comprises a first element 21, a second element 22, a third element 23 and the central element 24. The first element 21 is a pair of outer circumference portions that are installed as an arch extending from the one terminal 25 toward the other terminal 25. The second element 22 is installed as an arch extending continuously from the first element 21 toward the opposite terminal 25 along the inner circumference side of the first element 21. The third element 23 is installed as an arch further extending continuously from the second element 22 toward the opposite side to connect the central element 24.

Such emitter that is called a thermal electron emission type is electrically-heated through a pair of the terminals 25, and the tabular electron emission element 20 is energized with a predetermined electric current to a predetermined temperature (approximately 2400K-approximately 2500K), so that an electron beam E is emitted from the electron emission element 20.

The emitter 2 having such tabular electron emission element 20 is applied so that the size of the X-ray focal point can be further smaller. And the electron emission element 20 has a circular shape, as a plane view, of which center is the rotation center C of the envelope 12, so that the electron beam E can be evenly emitted even when the emitter 2 rotates, and consequently, the size of the X-ray focal point can be further smaller. In addition, the surface of the emitter 2 can be covered with an oxide film and so forth having a small work function. Further, relative to the emitter 2, the electron emission element 20 is just practically flat and the pair of the terminals 25 and the pair of the support members 26 cannot be subjected to the bending works.

FIGS. 8A, 8B are explanatory views illustrating the angle of the target surface 4 and the incident angle α of the electron beam E relative to the rotating envelope X-ray tube according to the aspect of the present invention. For the sake of shorthand, the magnetic field generator and some others are not shown in FIGS. 8A, 8B, but all will be well known to those of skill in the X-Ray Tube arts, since such individuals typically have advanced degrees in science, engineering, medical, and other technical fields.

Referring to FIGS. 8A, 8B, relative to the X-ray tube according to the aspect of the present invention, the angle θ between the emission direction of the electron beam E emitted from the emitter 2 of the cathode 1 and the target surface 4 of the anode 3 is at most (not more than) 90 degrees. Now, relative to the rotating envelope X-ray tube, the emission direction of the electron beam E emitted from the emitter 2 coincides with the rotation center C of the envelope 12. The angle between the emission direction of the electron beam E emitted from the emitter 2 of the cathode 1 and the target surface 4 of the anode 3 coincides with the angle θ between the rotation center of the envelope 12 and the target surface 4.

According to the conventional rotating envelope X-ray tube, such angle θ is larger (not less) than 90 degrees and slants toward the opposite side of the target surface 4 shown in FIGS. 8A, 8B. Referring to FIG. 14, for example, according to the conventional anode 3, the target surface 4 slants at an angle A and if such angle A is given 12 degrees, the angle θ is 102 degrees. When such aspect is adopted, as well as the conventional example shown in FIG. 15, the elongation L of the reflected electron (X-ray) relative to the incident electron is larger and in addition, the ratio η of the reflected electron relative to the incident electron is larger.

In contrast, referring to FIG. 15, when the electron beam E is incident from the slanted direction at an angle B relative to the target surface 4 of the anode 3 and such angle B is 30 degrees, the angle θ between the emission direction of the electron beam E emitted from the emitter 2 of the cathode 1 and the target surface 4 of the anode 3 is specified to be 60 degrees, i.e., less than 90 degree, so that the angle between the traveling direction of the electron beam when collides with the target surface 4 of the anode 3 and the target surface 4 can be specified to be perpendicular (i.e., the incident angle α is 0 degrees).

And referring additionally to FIG. 8B, a partial magnified view, when the incident angle α, which is the crossing angle between the trajectory of the electron beam E which is emitted from the emitter 2 of the cathode 1 and collides with the target surface 4 of the anode 3, and the normal on the target surface, is not more than 25 degrees, as set forth above, the elongation L is 1.1 times long, and the contribution of the electron beam E to the X-ray emission is approximately 95% based on that when the incident angle α is zero (0) degrees, so that the size of the X-ray focal point can be smaller, and further the electron beam E can be efficiently applied to the emission of the X-ray. When the incident angle α is not more than 12 degrees, as set forth above, the elongation L is 1.02 times long, and the contribution of the electron beam E to the X-ray emission is approximately 99% based on that when the incident angle α is zero degrees, so that the size of the X-ray focal point can be much smaller, and further the electron beam E can be more efficiently applied to the emission of the X-ray.

Specifically, relative to the rotating envelope X-ray tube according to the aspect of the present invention, the aspect in which the angle between the emission direction of the electron beam E and the target surface 4 of the anode 3 is at most 90 degrees is adopted and preferably, the incident angle α is specified at most 25 degrees and more preferably, the incident angle α is at most 12 degrees, and in addition, the emitter 2 having the tabular (flat) electron emission element 20 is applied, so that the entire device can be made compact and the diameter of the X-ray focal point can be smaller, and consequently, the electron beam E can be more efficiently utilized in the X-ray emission.

Next, the inventor sets forth the other Embodiments of the present invention. FIG. 9 is a schematic diagram illustrating a rotating envelope X-ray tube according to the aspect of the Embodiment 2 of the present invention, Further, the same member as the rotating envelope X-ray tube according to the aspect of the Embodiment 1 set forth above is not set forth in detail while providing the identical reference sign.

A rotating envelope X-ray tube, according to the aspect of the Embodiment 2, comprises a quadrupole lens, which consists of a pair of quadrupoles 6, between the cathode 1 and the magnetic field generator 5.

FIG. 10 is a schematic front view of the quadrupole 6 forming the quadrupole lens.

Such quadrupole 6 comprises four protrusions 61, which are formed at even intervals relative to the circular yoke 63, and each coil 62 winding each protrusion 61. Relative to such quadrupole 6, the four protrusions 61 and the four coils 62 generate alternately the N-pole and the S-pole. In such way, the quadrupole lens is formed by placing a pair of quadrupoles in the state of that quadrupoles 6 are distant at a constant distance and the polarity thereof are reversed, and the electric current that is provided the coil 62 therewith is controlled, so that the diameter of the electron beam passes through the quadrupole lens can be controlled. Accordingly, the diameter of the electron beam M the collides with the target surface 4 of the anode 3 can be smaller by using such quadrupole lens. In addition, as set forth as to the Embodiment 1, the circular yoke 63 is not required to be circular.

Relative to the rotating envelope X-ray tube according to the aspect of the Embodiment 2, the diameter of the electron beam E emitted from the emitter 2 of the cathode 1 is narrowed down by the quadrupole lens consisting of a pair of the quadrupoles 6. And the electron beam E is deflected by the magnetic field generator 5 and then collides with the target surface 4 of the anode 3.

Now, relative to the rotating envelope X-ray tube according to the aspect of the Embodiment 2, the quadrupole lens consisting of a pair of the quadrupoles 6 is in-place in the cathode 1 side and the magnetic field generator 5 is in-place in the anode 3 side. Even when the magnetic field generator 5 is in-place in the cathode 1 side and the quadrupole lens consisting of a pair of the quadrupoles 6 is in-place in the anode 3 side; the size of the entire device can be compact, and the diameter of the X-ray focal point can be smaller; and in addition, the electron beam E can be utilized efficiently for the X-ray emission, but the inside opening relative to the envelope 12 and the quadrupole 6 must be larger, so that the collision between the envelope 12 and the electron beam E can be avoided. Now, the distance between the quadrupoles 6 is longer, so that not only the sized just increases, but also the electric current flowing in the coil must increase to attain the equivalent lens-effect. Such requirement causes new issues that are heat generation of the coil and saturation of magnetic pole. In contrast, according to the aspect of the present Embodiment, when the quadrupole lens consisting of a pair of the quadrupoles 6 is in-place in the cathode 1 side and the magnetic field generator 5 is in-place in the anode 3 side, the size of the entire device can be more compact, but also an occurrence of such issue can be prevented.

Relative to the rotating envelope X-ray tube according to the aspect of the Embodiment 2 as well as the Embodiment 1, the angle θ between the emission direction of the electron beam E emitted from the emitter 2 of the cathode 1 and the target surface 4 of the anode 3 is at most 90 degrees. And the incident angle α, i.e., the crossing angle between the trajectory of the electron beam E when the electron beam E emitted from the emitter 2 of the cathode 1 collides with the target surface 4 of the anode 3 and the normal line on the target surface 4, is preferable at most 25 degrees and more preferable at most 12 degrees. Therefore, the size of the entire device can be compact, and the diameter of the X-ray focal point can be smaller, and in addition, the electron beam E can be utilized efficiently for the X-ray emission.

Next, the inventor further sets forth another Embodiment of the present invention. FIG. 11 is a schematic diagram illustrating a rotating envelope X-ray tube according to the aspect of the Embodiment 3 of the present invention. Further, the same member as the rotating envelope X-ray tube according to the aspect of the Embodiment 1, 2 set forth above is not set forth in detail while providing the identical reference sign.

A rotating envelope X-ray tube, according to the aspect of the Embodiment 3, comprises the quadrupole 6 shown in FIG. 10 and a composite member 7 combining the quadrupole and the magnetic field generator in order between the cathode 1 and the anode 3. Specifically, according to the aspect of the present Embodiment 3, the magnetic field generator is formed as a unit with the quadrupole in the anode side of the pair of the quadrupoles.

FIG. 12 is a schematic front view of the composite member 7.

Such composite member 7 comprises one circular yoke 73 and four protrusions 71 that are formed at even intervals relative to the circular yoke 73. Each protrusion 71 is winded with the coil 62 that configures the quadrupole, e.g., in FIG. 10 and with the coil 52 that configures a magnetic field generator, e.g., in FIG. 2. The coils 62 that configure the quadrupole generate alternately the N-pole and the S-pole, e.g., in FIG. 10. In addition, e.g., in FIG. 2, the coils 52 that configure the magnetic field generator quadrupole generate a pair of N-poles at the upper side in FIG. 12 and a pair of S-poles in the lower side therein. The composite member 7, according to such aspects, is operative to function as the quadrupole and function as the magnetic field generator with each coil 52 and each coil 62. In addition, for convenience sake, whereas it is illustrated as each of coil 52 and coil 62 winds each protrusion 71, both can be unified and an amount of electric current that flows the coils can added or subtracted. In addition, as set forth as to the Embodiment 1, the circular yoke 73 is not required to be circular.

Relative to the rotating envelope X-ray tube according to the aspect of the Embodiment 3, the diameter of the electron beam E emitted from the emitter 2 of the cathode 1 is narrowed down by the quadrupole lens consisting of the quadrupoles 6 and the quadrupole function due to the composite members 7. And the electron beam E is deflected by the magnetic field generator of the composite member 7 and then collides with the target surface 4 of the anode 3.

Now, relative to the rotating envelope X-ray tube according to the aspect of the Embodiment 3, the function of the quadrupole lens consisting of the quadrupoles 6 and the composite members 7 is operative at the cathode 1 side and the function of the magnetic field generation is operative in the anode 3 side. Therefore, as well as the aspect of the Embodiment 2, the inside opening relative to the quadrupole 6 is formed larger, so that any possibly occurring issue can be avoided. In addition, the single composite member 7 is capable of being operative to function as the quadrupole and the magnetic generator, so that the size of the envelope 12 from the cathode 1 to the anode 3 can be made much compact.

Relative to the rotating envelope X-ray tube according to the aspect of the Embodiment 3 as well as the Embodiment 1, 2, the angle θ between the emission direction of the electron beam E emitted from the emitter 2 of the cathode 1 and the target surface 4 of the anode 3 is at most (not more than) 90 degrees. And the incident angle α, i.e., the crossing angle between the trajectory of the electron beam E when the electron beam E emitted from the emitter 2 of the cathode 1 collides with the target surface 4 of the anode 3 and the normal line on the target surface 4, is preferably at most 25 degrees and more preferably at most 12 degrees. Therefore, the size of the entire device can be compact, and the diameter of the X-ray focal point can be smaller, and in addition, the electron beam E can be utilized efficiently for the X-ray emission.

FIG. 13 is a schematic front view of the composite member 7 according to another Embodiment.

Referring to FIG. 12, relative to the composite member 7, the four protrusions 71 that are formed at even intervals relative to the circular yoke 73 are winded with the coil 62 that configures the quadrupole and the coil 52 that configures a magnetic field generator. In contrast, referring to FIG. 13, the four protrusions 71 are winded only with the coil 62 that configures the quadrupole and the circular yoke 73 is winded with the coil 52 that configures a magnetic field generator.

Even when such structure is adopted, the single composite member 7 is capable of being operative to function as the quadrupole and the magnetic generator, so that the size of the envelope 12 from the cathode 1 to the anode 3 can be made much compact. Such aspect shortens the traveling distance of the electron, so that the impact of the space-charge effect can be reduced, and the diameter of the X-ray focal point can be much smaller.

As set forth above, relative to the rotating envelope X-ray tube according to the Embodiment 1 to 3 of the present invention, the size of the entire device can be compact, and the diameter of the X-ray focal point can be smaller, and in addition, the electron beam can be utilized efficiently for the X-ray emission.

### REFERENCE OF SIGNS

1 Cathode
2 Emitter
3 Anode
4 Target surface
5 Magnetic field generator
6 Quadrupole
7 Composite member
11 Support axis
12 Envelope
20 Electron emission element
25 Terminal element
51 Protrusion
52 Coil
53 Yoke
61 Protrusion
62 Coil
63 Yoke
71 Protrusion
73 Yoke
C Rotation center
E Electron beam
X X-ray
α Incident angle

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A rotating envelope X-ray tube, comprising:
a cathode that emits an electron beam;
an anode that emits an X-ray when said electron beam emitted from said cathode collides therewith;
a magnetic field generator that deflects said electron beam emitted from said cathode onto said anode; and
an envelope that houses said cathode and said anode inside thereof;
wherein said anode and said envelope rotate in a unified manner, and an angle between an emission direction of said electron beam emitted from said cathode and a target surface of said anode is at most 90 degrees.

2. The rotating envelope X-ray tube, according to claim 1, wherein:
a crossing angle between a trajectory of said electron beam at said anode and a normal line on said target surface is at most 25 degrees.

3. The rotating envelope X-ray tube, according to claim 2, wherein:
a crossing angle between a trajectory of said electron beam at said anode and a normal line on said target surface is at most 12 degrees.

4. The rotating envelope X-ray tube, according to claim 2, wherein:
said cathode further comprises an emitter, having a planar surface that emits an electron.

5. The rotating envelope X-ray tube, according to claim 2, wherein:
a quadrupole lens is between said cathode and said magnetic field generator; and
said quadrupole lens consists of a pair of quadrupoles.

6. The rotating envelope X-ray, tube according to claim 5, wherein:
said magnetic field generator is formed as a unit with an anode-side quadrupole of said pair of quadrupoles.

7. A rotating envelope X-ray tube, comprising:
a cathode that emits an electron beam;
an anode that emits an X-ray when said electron beam emitted from said cathode collides therewith;
a magnetic field generator that deflects said electron beam emitted from said cathode onto said anode;
an envelope that houses said cathode and said anode in an inside thereof;
said anode and said envelope rotate in a unified manner; and
a crossing angle between a trajectory of said electron beam at said anode and a normal line on said target surface is at most 25 degrees.

8. The rotating envelope X-ray tube, according to claim 7, wherein:
a crossing angle between a trajectory of said electron beam at said anode and a normal line on said target surface is at most 12 degrees.

9. The rotating envelope X-ray tube, according to claim 7, wherein:
said cathode further comprises:
an emitter, having a planar surface that emits an electron.

10. The rotating envelope X-ray tube, according to claim 7, further comprising:
a quadrupole lens between said cathode and said magnetic field generator; and
said quadrupole lens consists of a pair of quadrupoles.

11. The rotating envelope X-ray tube, according to claim 10, wherein:
said magnetic field generator is formed as a unit with an anode-side quadrupole of said pair of quadrupoles.
